(19) United States
(12) Patent Application Publication
(10) Pub. No.: US 2016/0273510 A1
(43) Pub. Date: Sep. 22, 2016

(54) HYDRAULIC MACHINE AND METHOD FOR OPERATING THE SAME

(71) Applicant: KABUSHIKI KAISHA TOSHIBA, Minato-ku (JP)

(72) Inventors: Toshimasa MUKAI, Kamakura (JP); Akira SHINOHARA, Adachi (JP); Noriko IKI, Yokohama (JP)

(73) Assignee: KABUSHIKI KAISHA TOSHIBA, Minato-ku (JP)

(21) Appl. No.: 15/062,765

(22) Filed: Mar. 7, 2016

(30) Foreign Application Priority Data
Mar. 17, 2015 (JP) 2015-053748

(51) Int. Cl. F03B 11/00; F03B 3/18; F03B 3/02

(52) U.S. Cl. CPC F03B 11/002; F03B 3/02; F03B 3/183; F05B 2220/32

(57) ABSTRACT

A hydraulic machine according to an embodiment includes an inlet section into which water flowing from an upper pond flows, a runner configured to be rotated by water flowing out from the inlet section, an outlet section configured to flow out water flowing out from the runner to a lower stream, and a micro-nano bubble generator configured to generate water containing micro-nano bubbles. The micro-nano bubble generator supplies the water containing micro-nano bubbles to water flowing inside the hydraulic machine from a portion between the inlet section and the outlet section of the hydraulic machine.

### CROSS REFERENCE TO RELATED APPLICATIONS

This application is based upon and claims the benefit of priority from the prior Japanese Patent Application No. 2015-53748, filed on 17 Mar. 2015, the entire contents of which are incorporated herein by reference.

### FIELD

Embodiments described herein relate to a hydraulic machine and a method for operating the hydraulic machine.

### BACKGROUND

There are various types of hydraulic machines that obtain mechanical energy through water introduced from an upper pond. For example, in a Francis turbine-type hydraulic machine, water introduced from the upper pond passes through an iron tube to be guided to a casing. The flow velocity of the water is made constant through the casing and the water then flows into a runner through stay vanes and guide vanes for adjusting the flow amount, both of which are disposed on an inner circumference side of the casing. The runner is rotated by the energy of the water passing therethrough and drives a generator motor coupled thereto through a main shaft. As a result, electric power is generated by the generator motor. The water that has flowed out from the runner flows out to a lower pond or a drainage channel through a draft tube.

Meanwhile, a dissolved oxygen concentration in the water of the upper pond (a reservoir on an upstream side) described above varies depending on a factor such as a depth of water, or change in temperature. Particularly, the dissolved oxygen concentration in water being present on the bottom of a pond may be lowered to a few milligrams per liter from summer to autumn. It has been known in the past that, in a case where such water with a lower dissolved oxygen concentration is taken and flowed out to the lower pond from the hydraulic machine, the dissolved oxygen required for the life of aquatic animals living in the lower pond becomes insufficient, which may affect an ecosystem.

Therefore, there have been proposed thus far techniques for increasing the dissolved oxygen concentration in the water of the lower pond, for example, by discharging air or ozone and so on from the bottom of the lower pond, or by supplying air to water flowing inside the hydraulic machine. Specifically, hydraulic machines for increasing the dissolved oxygen concentration in water passing through the inside thereof have been known in the past, such as one that supplies air from air supply ports provided in a runner-side pressure chamber and on an inner wall of the draft tube.

However, a configuration including the air supply port for supplying air provided in the runner-side pressure chamber or on the inner wall of the draft tube, as in the case of the aforementioned hydraulic machine, makes it difficult for air to be dissolved into water in a case where the flow velocity of water is low or a larger amount of air is supplied. Moreover, an air supply port finely formed in such hydraulic machine allows air to be easily dissolved into water but there is a risk of clogging in the air supply port. Therefore, there still has been room for improvement in surely increasing the dissolved oxygen concentration in water.

### BRIEF DESCRIPTION OF THE DRAWINGS

FIG. 1 is a schematic view of a hydraulic machine according to a first embodiment;

FIG. 2 is a graph comparing changes in dissolved oxygen concentrations in water between a case where micro-nano bubbles are supplied to water and a case where air bubbles are supplied to water from a typical diffuser tube;

FIG. 3 is a schematic view of a hydraulic machine according to a second embodiment;

FIG. 4 is a schematic view of a hydraulic machine according to a third embodiment;

FIG. 5 is a schematic view of a hydraulic machine according to a fourth embodiment;

FIG. 6 is a schematic view of a hydraulic machine according to a fifth embodiment;

FIG. 7 is a schematic view of a hydraulic machine according to a sixth embodiment; and

FIG. 8 is a schematic view of a hydraulic machine according to a seventh embodiment.

### DETAILED DESCRIPTION

Embodiments will now be explained with reference to the accompanying drawings.

A hydraulic machine according to an embodiment includes an inlet section into which water flowing from an upper pond flows, a runner configured to be rotated by water flowing out from the inlet section, and an outlet section configured to flow out water flowing out from the runner to a lower stream. The hydraulic machine further includes a micro-nano bubble generator configured to generate water containing micro-nano bubbles. The micro-nano bubble generator supplies the water containing micro-nano bubbles to water flowing inside the hydraulic machine from a portion between the inlet section and the outlet section of the hydraulic machine.

A method for operating a hydraulic machine according to an embodiment is a method for operating a hydraulic machine including an inlet section into which water flowing from an upper pond flows, a runner configured to be rotated by water flowing out from the inlet section, and an outlet section configured to flow out water flowing out from the runner to a lower stream. This method includes the step of: installing a micro-nano bubble generator configured to generate water containing micro-nano bubbles in the hydraulic machine; and supplying the water containing micro-nano bubbles generated by the micro-nano bubble generator to water flowing inside the hydraulic machine from a portion between the inlet section and the outlet section of the hydraulic machine.

Hereinafter, each of the embodiments according to the present invention will be described in detail with reference to the accompanying drawings.

### First Embodiment

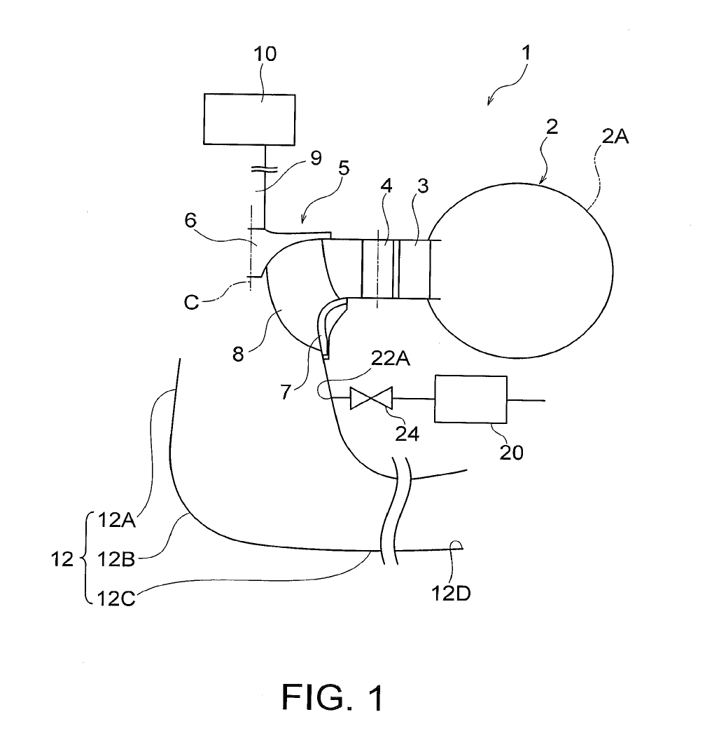

FIG. 1 illustrates a hydraulic machine 1 according to a first embodiment of the invention. The hydraulic machine 1 according to the embodiment is exemplarily configured as a Francis turbine. The hydraulic machine 1 includes a casing 2 into which water flows from an upper pond (not illustrated) through an iron tube, a plurality of stay vanes 3, a plurality of guide vanes 4, and a runner 5. The casing 2 includes, at an end portion thereof on an upstream side, an inlet section 2A into which water flowing from the upper pond flows. The inlet section 2A is indicated by a double-dot chain line in the drawing for convenience of description. In this example, the flow velocity of water flowing into the inlet section 2A is made constant inside the casing 2 and the water flows out to the stay vanes 3.

The stay vanes 3, which guide water flowing out from the casing 2 to the guide vanes 4 and the runner 5, are disposed at an inner circumference side of the casing 2 at predetermined intervals in a circumferential direction. The guide vanes 4, which guide water flowing thereinto to the runner 5, are disposed at predetermined intervals in the circumferential direction. Each of the guide vanes 4 is rotatably provided and configured such that an amount of water flowing into the runner 5 can be adjusted by changing the aperture thereof through rotation.

The runner 5 is configured to be rotatable about a rotation axis line C relative to the casing 2 and rotated by water flowing out from the guide vanes 4. The runner 5 includes a crown 6, a band 7, and a plurality of runner blades 8 provided between the crown 6 and the band 7. The runner blades 8 are disposed at predetermined intervals in the circumferential direction. A generator motor 10 is coupled to the runner 5 through a main shaft 9. The generator motor 10 functions not only as an electric generator that generates electric power through rotation of the runner 5 during operation of the water turbine but also as an electric motor that rotates the runner 5 during operation of a pump. The generator motor 10 is driven by the runner 5 to generate electric power.

Additionally, a draft tube 12 is provided on a downstream side of the runner 5. The draft tube 12 includes an upper draft 12A, a bending portion 12B, and a downstream enlarged portion 12C. The upper draft 12A becomes larger in cross-sectional area toward the downstream side away from the runner 5. The bending portion 12B bends from an end portion of the upper draft 12A on the downstream side. The downstream enlarged portion 12C becomes larger in cross-sectional area toward the downstream side away from the bending portion 12B. The downstream enlarged portion 12C of the draft tube 12 is coupled to a lower pond (through a drainage channel). The downstream enlarged portion 12C includes, at an end portion thereof on the downstream side, an outlet section 12D configured to flow out water to the lower pond.

In FIG. 1, a micro-nano bubble generator 20 is included in the hydraulic machine 1. The micro-nano bubble generator 20 is configured to generate water containing a large amount of micro-nano bubbles to supply to water flowing inside the hydraulic machine 1. The micro-nano bubble generator 20 is provided for the purpose of increasing a dissolved oxygen concentration in water flowing inside the hydraulic machine 1, thereby increasing the dissolved oxygen concentration in the water of the lower pond located on the downstream side thereof.

In the embodiment, an injection port 22A is formed on a wall surface of the upper draft 12A of the draft tube 12. The micro-nano bubble generator 20 supplies the generated water containing micro-nano bubbles to water flowing inside the hydraulic machine 1 from the injection port 22A. In the example illustrated in the drawing, a valve member 24 is provided between the injection port 22A and the micro-nano bubble generator 20. The valve member 24 can be opened and closed to switchably supply and block the water containing micro-nano bubbles from the micro-nano bubble generator 20 to the inside of the hydraulic machine 1. In addition, the valve member 24 may be configured to adjust the flow amount of the water containing micro-nano bubbles through the adjustment of the aperture thereof.

In the embodiment, bubbles which are generally called micro bubble and nano bubble are collectively referred to as “micro-nano bubbles” and the micro-nano bubble means an air bubble having a diameter of approximately 50 μm or smaller. The micro-nano bubble has a characteristic that an air bubble having a diameter of larger than 50 μm does not have. For example, the air bubble having a diameter of larger than 50 μm (typical air bubble) rises up through water due to hydraulic pressure and disappears by bursting on a water surface. Compared to this, the micro-nano bubble is reduced in size under water and dissolved into water. For this reason, a larger amount of micro-nano bubbles can be dissolved into water than the typical air bubbles and thus the dissolved oxygen concentration can be favorably increased.

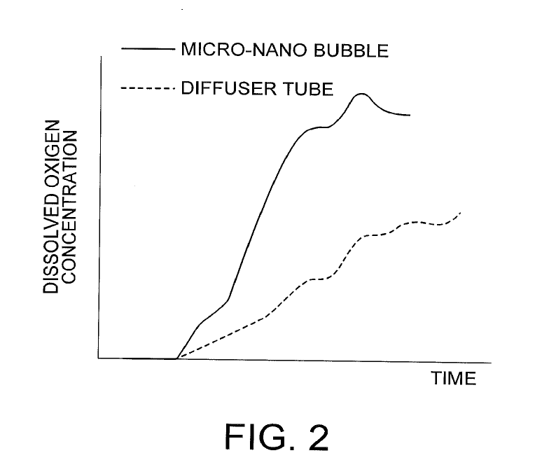

FIG. 2 is a graph comparing changes in the dissolved oxygen concentrations in water between a case where the micro-nano bubbles are supplied to water within a tank with a constant flow amount and a case where the air bubbles larger than the micro-nano bubbles are supplied to water within the tank from a typical diffuser tube with a constant flow amount. In this graph, the change in the dissolved oxygen concentration in water supplied with the micro-nano bubbles is indicated by a solid line, whereas the change in the dissolved oxygen concentration in water supplied with the air bubbles from the typical diffuser tube is indicated by a dashed line. As illustrated in FIG. 2, in the case of the micro-nano bubbles supplied to water, the dissolved oxygen concentration in water is increased substantially twice the case of the air bubbles supplied to water from the typical diffuser tube. It is clear also from this result that the micro-nano bubble is suitable for increasing the dissolved oxygen concentration.

Examples of a technique for generating the water containing micro-nano bubbles include the following techniques 1 and 2.

1. A technique in which a gas such as air is injected into water and the injected gas is sheared through water flow, a shape of a flow channel through which the gas passes, or the like, to make the air bubbles finer.

2. A technique applying Henry's law where a liquid under a higher pressure has a higher solubility of gas when a gas is dissolved into the liquid. For example, a sufficient amount of gas is dissolved into water stored in a pressure tank under a high pressure and the water is then drained from the pressure tank while the pressure is suddenly reduced, thereby changing the dissolved gas to fine air bubbles.

Either of the techniques 1 and 2 described above may be employed for the micro-nano bubble generator 20 according to the embodiment. Alternatively, another technique may be employed. It is desirable that a favorable method or product be employed for the micro-nano bubble generator 20 by considering a flow amount and flow velocity of water depending on an installation condition of the hydraulic machine, a capacity of supplying the micro-nano bubbles to water for generation of the water containing micro-nano bubbles, the degree of increase in the dissolved oxygen concentration in water for generation of the water containing micro-nano bubbles, a facility operation cost, and the like. In recent years, the Micro-Nano Bubble Society Corporation has been established in Japan in 2012. This has rapidly accelerated research in various fields and development of products relating to the micro-nano bubble. Accordingly, it is expected that generation of the micro-nano bubbles using a new method or product will be achieved. It is thus expected as well that methods or products that can be favorably used for different types of the hydraulic machines will be expanded.

In regard to water used by the micro-nano bubble generator 20 to generate the water containing micro-nano bubbles, water stored in a water storage tank (not illustrated) or the like may be used. However, securing of such water used for the generation is not limited to the manner described above. For example, part of water flowing inside the hydraulic machine 1 may be used for generation of the water containing micro-nano bubbles.

Next, operation of the embodiment will be described.

In the hydraulic machine 1 illustrated in FIG. 1, water introduced from the upper pond passes through the iron tube to be guided to the inlet section 2A of the casing 2. The flow velocity of the water is made constant through the casing 2 and the water then flows into the runner 5 through the stay vanes 3 and the guide vanes 4 which are disposed on the inner circumference side of the casing 2. The runner 5 is rotated by the energy of the water passing therethrough and drives the generator motor 10 coupled thereto through the main shaft 9. As a result, electric power is generated by the generator motor 10. The water that has flowed out from the runner 5 flows out to the lower pond through the outlet section 12D of the draft tube 12.

During such operation, the micro-nano bubble generator can supply the water containing a large amount of micro-nano bubbles to water flowing inside the hydraulic machine 1. The water containing micro-nano bubbles may be supplied intermittently or continuously. Alternatively, any amount of the water containing micro-nano bubbles may be supplied at any timing.

A higher pressure is applied to water flowing inside the hydraulic machine 1 on the upstream side of the runner 5 due to a difference in the height from the upper pond to the runner 5 and then the hydraulic pressure is reduced by being converted to rotation energy at the runner 5. Additionally, because a flow channel is expanded at the draft tube 12, the flow velocity of the water is lowered. Once the water containing micro-nano bubbles is supplied to such water flowing inside the hydraulic machine 1, the micro-nano bubbles are diffused into water due to change in the pressure of water moving from the upstream side to the downstream side of the runner 5. Meanwhile, the micro-nano bubbles are in contact with water with a lower velocity for a longer period of time on the downstream side of the runner 5. Thus, the micro-nano bubbles are dissolved into water with more ease. As a result, the dissolved oxygen concentration of water flowing inside the hydraulic machine 1 is surely increased.

In a typical technique for supplying air to water flowing inside the hydraulic machine, there is a risk of difficulties in dissolving air into water in a case where the flow velocity of water is low or a larger amount of air is supplied. In other words, it is difficult for air to be dissolved into water in some cases depending on the operation condition of the hydraulic machine. On the other hand, in the configuration according to the embodiment, the water containing micro-nano bubbles is generated in advance and supplied to water flowing inside the hydraulic machine 1. Consequently, regardless of the operation condition of the hydraulic machine 1, the dissolved oxygen concentration in water flowing inside the hydraulic machine 1 can be always increased in a stable condition. Additionally, regardless of the size or the shape of the injection port 22A, the dissolved oxygen concentration in water can be increased in a stable condition. Thus, an effect that increases the dissolved oxygen concentration can be obtained without a finely formed injection port 22A. As a result, the injection port 22A can be also prevented from clogging.

Therefore, the hydraulic machine 1 according to the embodiment can flow out, to the lower stream, water with the dissolved oxygen concentration surely increased. In addition, the dissolved oxygen concentration in the water of the lower pond can be surely increased and an ecosystem of aquatic animals living in the lower pond can be favorably maintained. This is because the micro-nano bubble stays under water for a longer period of time than the air bubble having a diameter of larger than 50 μm and accordingly most of the micro-nano bubbles will stay under water even in the lower stream after passing through the hydraulic machine 1, that is, the lower pond. The dissolved oxygen concentration in the water of the lower pond is thus increased surely. Meanwhile, in the configuration according to the embodiment, water flowing out from the hydraulic machine 1 churns the water of the lower pond, whereby the dissolved oxygen concentration in the entire lower pond can be efficiently increased.

When the dissolved oxygen concentration in water is high in the hydraulic machine 1, cavitation occurs easily. Particularly, this can cause a problem of erosion on a wing surface of the runner blade 8 or the like. It is thus desirable, in a case where the water containing micro-nano bubbles is supplied to water, to supply from a position on the downstream side of the runner 5. For this reason, the embodiment includes the injection port 22A formed in the upper draft 12A of the draft tube 12. The water containing micro-nano bubbles is supplied from the injection port 22A. As a result, influence of occurrence of the cavitation is suppressed on the wing surface of the runner blade 8 or the like.

In addition, an air supply tube or a manhole has been often provided in the upper draft 12A in the past. It is thus not difficult to provide the injection port 22A at this position. In the case of the injection port 22A located on the downstream side of the runner 5, the water containing micro-nano bubbles is largely diffused by the swirl flow of the runner 5. Therefore, an effect that causes the micro-nano bubbles to be efficiently dissolved into water with ease is also expected.

Consequently, in the hydraulic machine 1 according to the embodiment, an effect that increases the dissolved oxygen concentration in water to be flowed out to the lower stream can be achieved without a major design change of the hydraulic machine from a conventional structure and damage to a structure such as the runner 5 due to the cavitation.

### Second Embodiment

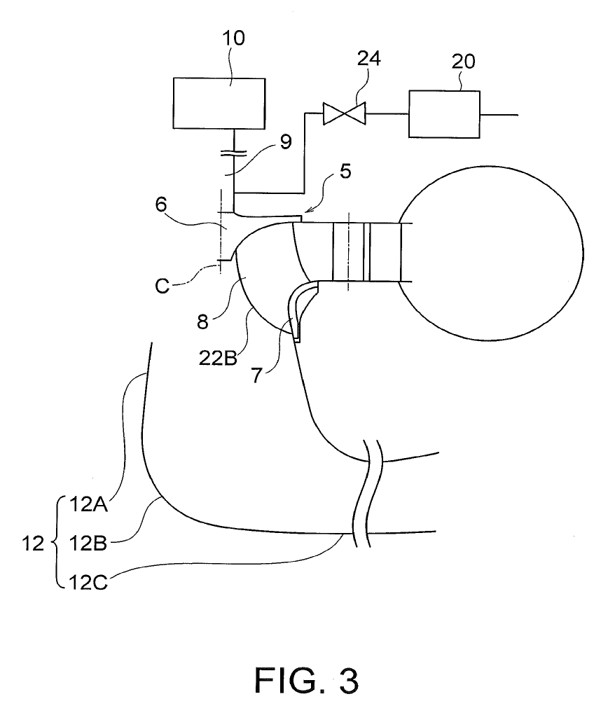

FIG. 3 is a schematic view of a hydraulic machine according to a second embodiment of the invention. In the embodiment, similar components to those in the aforementioned first embodiment are given the same reference numerals and the description thereof will be omitted.

As illustrated in FIG. 3, an injection port 22B according to the embodiment is formed at an end portion of a runner blade 8 on the downstream side to supply the water containing micro-nano bubbles to the inside of the hydraulic machine. In the example illustrated in the drawing, a micro-nano bubble generator 20 is configured to supply the water containing micro-nano bubbles to the inside of the hydraulic machine from the injection port 22B through a main shaft 9 and a crown 6.

In the second embodiment having such a configuration, in a similar manner to the aforementioned first embodiment, the influence of occurrence of the cavitation is suppressed on the wing surface of the runner blade 8 or the like. The water containing micro-nano bubbles supplied from the injection port 22B is also swirled by the revolution of a rotating runner 5. As a result, the water containing micro-nano bubbles can be diffused largely and therefore the micro-nano bubbles are sufficiently dissolved into water with ease.

According to the embodiment described above, the dissolved oxygen concentration in water to be flowed out to the lower stream can be increased without damage to a structure such as the runner 5 due to the cavitation. Additionally, the water containing micro-nano bubbles can be diffused largely to achieve an effect that efficiently increases the dissolved oxygen concentration in water to be flowed out to the lower stream.

### Third Embodiment

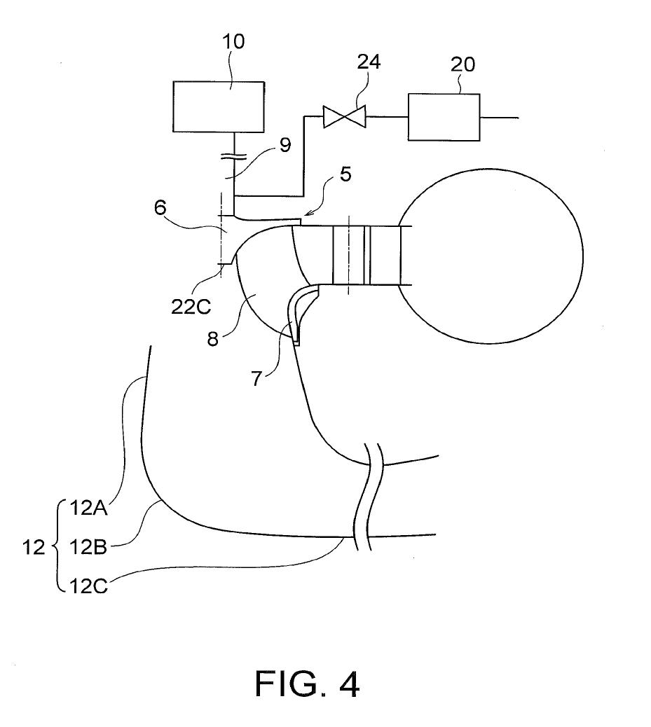

FIG. 4 is a schematic view of a hydraulic machine according to a third embodiment of the invention. In the embodiment, similar components to those in the aforementioned first and second embodiments are given the same reference numerals and the description thereof will be omitted.

As illustrated in FIG. 4, an injection port 22C according to the embodiment is formed at an end portion of a main shaft 9 on the side of a runner 5. A micro-nano bubble generator 20 is configured to supply the water containing micro-nano bubbles to water flowing inside the hydraulic machine from the injection port 22C.

In the third embodiment having such a configuration, in a similar manner to the aforementioned first embodiment and the like, the influence of occurrence of the cavitation is suppressed on the wing surface of a runner blade 8 or the like. Additionally, some hydraulic machines are configured to supply air from the end portion of the main shaft 9 on the side of the runner 5 to suppress the swirl flow. Therefore, it is easy in the configuration according to the embodiment to form a channel from the micro-nano bubble generator 20 to the injection port 22C.

Meanwhile, the rotation center of the runner 5 is located in a region on the downstream side of the end portion of the main shaft 9 on the side of the runner 5 and thus the hydraulic pressure therein is low due to swirl of water. Accordingly, the water containing micro-nano bubbles can be supplied to water under a relatively low pressure and then the micro-nano bubbles can be diffused largely into water due to change in pressure. As a result, the micro-nano bubbles are sufficiently dissolved into water with ease.

According to the embodiment described above, the dissolved oxygen concentration in water to be flowed out to the lower stream can be increased without damage to a structure such as the runner 5 due to the cavitation and a major design change of the hydraulic machine from a conventional structure. Additionally, the micro-nano bubbles can be largely diffused into water to achieve an effect that efficiently increases the dissolved oxygen concentration in water to be flowed out to the lower stream.

### Fourth Embodiment

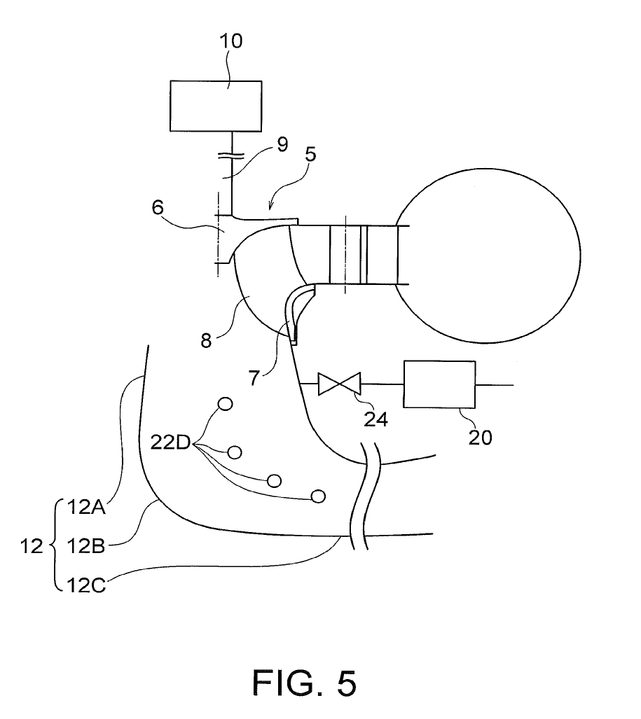

FIG. 5 is a schematic view of a hydraulic machine according to a fourth embodiment of the invention. In the embodiment, similar components to those in the aforementioned first to third embodiments are given the same reference numerals and the description thereof will be omitted.

As illustrated in FIG. 5, a plurality of injection ports 22D according to the embodiment is formed in a wide range of a wall surface of a draft tube 12 to supply the water containing micro-nano bubbles to the inside of the hydraulic machine. Specifically in this example, the plurality of injection ports 22D is formed in an upper draft 12A and a bending portion 12B.

In the fourth embodiment having such a configuration, in a similar manner to the aforementioned first embodiment and the like, the influence of occurrence of the cavitation is suppressed on the wing surface of a runner blade 8 or the like.

Additionally, a micro-nano bubble generator 20 according to the embodiment generates the micro-nano bubbles in advance to supply water to the inside of the hydraulic machine. Consequently, regardless of the shape of the injection port or the operation condition of the hydraulic machine, the dissolved oxygen concentration can be increased. However, in order to efficiently increase the dissolved oxygen concentration, it is important to diffuse a large amount of the water containing micro-nano bubbles into water. It is thus desirable to supply the water containing micro-nano bubbles from a plurality of any positions. In accordance with this situation, a larger region of the draft tube 12 in which the injection ports can be formed is secured in the embodiment and thus any number of the injection ports 22D can be formed relatively freely at any positions. As a result, a large amount of the water containing micro-nano bubbles can be diffused into water with ease.

According to the embodiment described above, an effect that efficiently increases the dissolved oxygen concentration in water to be flowed out to the lower stream can be achieved.

### Fifth Embodiment

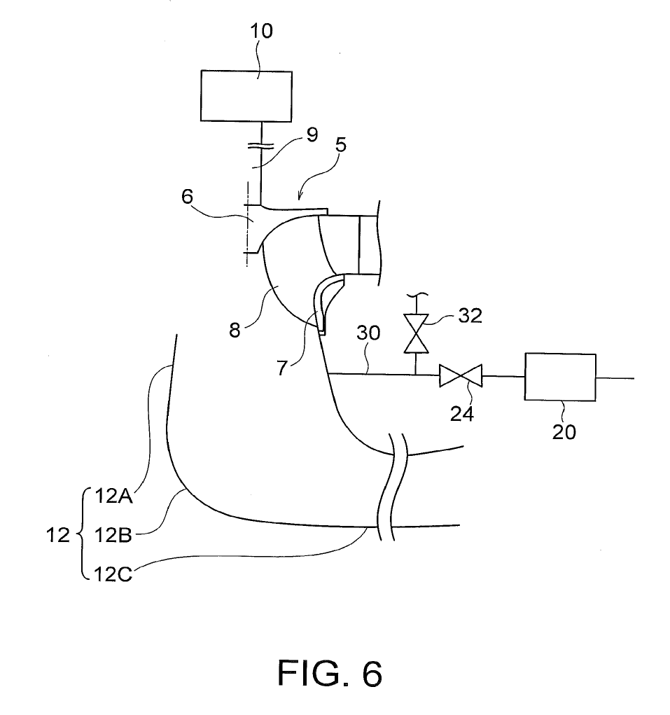

FIG. 6 is a schematic view of a hydraulic machine according to a fifth embodiment of the invention. In the embodiment, similar components to those in the aforementioned first to fourth embodiments are given the same reference numerals and the description thereof will be omitted.

As illustrated in FIG. 6, an air supply tube 30, one end portion of which opens on a wall surface of an upper draft 12A of a draft tube 12, is provided in the embodiment. The air supply tube 30 is provided to reduce vibration by supplying air to the inside of the draft tube 12 in a case where the vibration is caused by a strong swirl flow occurring inside the draft tube 12. The swirl flow described above sometimes occurs in the case of, for example, a partial load condition in which the hydraulic machine is operated off a design point thereof. The air supply tube 30 includes a selector valve 32. The selector valve 32 is opened and closed to switch on and off the air supply through the air supply tube 30.

A micro-nano bubble generator 20 according to the embodiment is connected to the air supply tube 30. The micro-nano bubble generator 20 is configured to supply the water containing micro-nano bubbles to water flowing inside the hydraulic machine through the air supply tube 30.

Many hydraulic machines include the air supply tube 30. The fifth embodiment uses part of the air supply tube 30 to supply the water containing micro-nano bubbles to water flowing inside the hydraulic machine.

According to the embodiment described above, an effect that adds, to the hydraulic machine, a function that increases the dissolved oxygen concentration in water can be achieved at a lower cost. FIG. 6 illustrates a configuration in which the air supply tube 30 supplies air from the draft tube 12. However, an air supply tube that supplies air from an end portion of a main shaft 9 is also known. The water containing micro-nano bubbles may be supplied using such an air supply tube as a variation.

### Sixth Embodiment

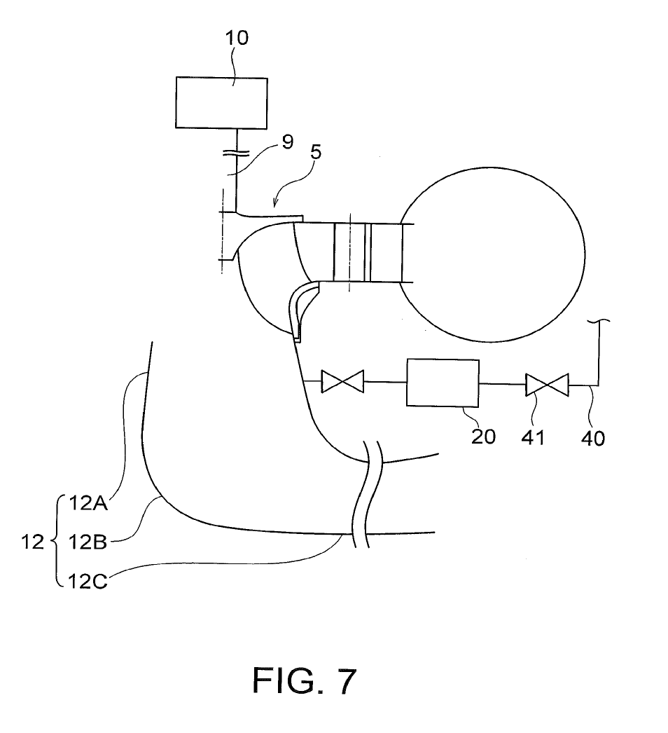

FIG. 7 is a schematic view of a hydraulic machine according to a sixth embodiment of the invention. In the embodiment, similar components to those in the aforementioned first to fifth embodiments are given the same reference numerals and the description thereof will be omitted.

A conduit tube 40 is provided in the embodiment to supply water flowing on the upstream side of a runner 5 to a micro-nano bubble generator 20. The micro-nano bubble generator 20 uses the water from the conduit tube 40 to generate the water containing micro-nano bubbles. The conduit tube 40 includes a selector valve 41. The selector valve 41 is opened and closed to switchably supply and block the water from the upstream side of the runner 5 to the micro-nano bubble generator 20. In the example illustrated in the drawing, the water containing micro-nano bubbles is supplied from an upper draft 12A of a draft tube 12.

In the embodiment, by supplying the water flowing on the upstream side of the runner 5 to the micro-nano bubble generator 20, it is not necessary to secure water to be injected or prepare a facility such as a water storage tank.

Additionally, the micro-nano bubble generator 20 according to the embodiment is supplied with water under a high pressure upon opening the selector valve 41. The micro-nano bubbles are mixed into the water under a high pressure such that the water containing micro-nano bubbles is generated to be supplied to water flowing inside the hydraulic machine. Here, a large amount of gas can be dissolved into the water under a high pressure (Henry's law). Therefore, by using the micro-nano bubble generator 20 according to the embodiment, a large amount of micro-nano bubbles can be dissolved into water and thus the dissolved oxygen concentration of the water containing micro-nano bubbles can be efficiently increased. Such water containing micro-nano bubbles is then supplied to water under a low pressure on the downstream side of the runner 5. Consequently, the micro-nano bubbles can be made finer and the micro-nano bubbles are sufficiently dissolved into water with ease.

As described in the aforementioned first embodiment, examples of the technique for generating the water containing micro-nano bubbles include the technique in which a sufficient amount of gas is dissolved into water stored in a pressure tank under a high pressure and the water is then drained from the pressure tank while the pressure is suddenly reduced, thereby changing the dissolved gas to fine air bubbles (technique 2). The micro-nano bubble generator 20 according to the embodiment uses the water under a high pressure on the upstream side of the runner 5 such that power for applying pressure to the pressure tank can be reduced or the pressure tank itself can be omitted in technique 2. In addition, the water containing micro-nano bubbles is supplied from the micro-nano bubble generator 20 to the water under a low pressure on the downstream side of the runner 5 such that power for a pressure changing facility that reduces pressure can be reduced or the pressure changing facility itself can be omitted in technique 2.

Accordingly, it is not necessary in the embodiment to secure water to be injected or prepare a facility such as a water storage tank for the micro-nano bubble generator 20, while energy-saving and simplification of the micro-nano bubble generator 20 itself can be realized. This achieves an effect that efficiently increases the dissolved oxygen concentration in water to be flowed out to the lower stream at a lower cost.

### Seventh Embodiment

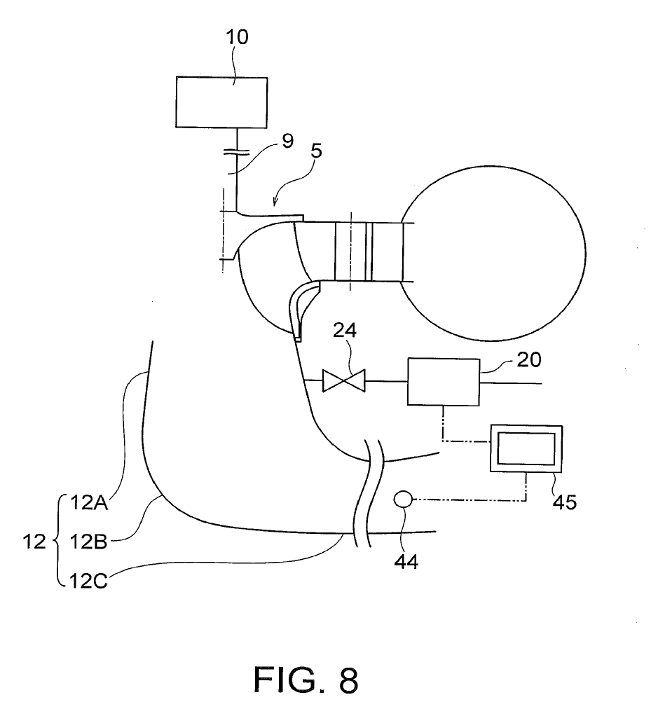

FIG. 8 is a schematic view of a hydraulic machine according to a seventh embodiment of the invention. In the embodiment, similar components to those in the aforementioned first to sixth embodiments are given the same reference numerals and the description thereof will be omitted.

As illustrated in FIG. 8, a dissolved oxygen concentration measuring unit 44 is provided in the embodiment at a position on the downstream side of a position through which the water containing micro-nano bubbles is supplied from a micro-nano bubble generator 20 to water flowing inside the hydraulic machine 1 (supply position). In the example illustrated in the drawing, the water containing micro-nano bubbles is supplied from an injection port formed on a wall surface of an upper draft 12A of a draft tube 12. The dissolved oxygen concentration measuring unit 44 is provided in a downstream enlarged portion 12C of the draft tube 12.

A control unit 45 is connected to the micro-nano bubble generator 20 and the dissolved oxygen concentration measuring unit 44. The control unit 45 is configured to control, based on a measurement result of the dissolved oxygen concentration measuring unit 44, a flow amount of the water containing micro-nano bubbles supplied by the micro-nano bubble generator 20 and/or a mixed amount of the micro-nano bubbles mixed in the supplied water. Specifically, the control unit 45 controls the micro-nano bubble generator 20 such that the dissolved oxygen concentration measured by the dissolved oxygen concentration measuring unit 44 matches a predetermined dissolved oxygen concentration.

According to the embodiment, the dissolved oxygen concentration in water can be controlled to be a desired value. As a result, in a case where the dissolved oxygen concentration in water flowed out to the downstream side of the draft tube 12 exceeds a predetermined concentration, for example, the output of the micro-nano bubble generator 20 can be adjusted and the power can be thereby saved. Additionally, an adverse influence on the environment due to an excessive dissolved oxygen concentration can be prevented. In the embodiment, the water containing micro-nano bubbles is supplied from the upper draft 12A of the draft tube 12. However, also in a case where the water containing micro-nano bubbles is supplied from another position, the dissolved oxygen concentration measuring unit 44 and the control unit 45 according to the embodiment can be applied.

According to each of the embodiments described thus far, water with the dissolved oxygen concentration surely increased can be flowed out to the lower stream.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the invention.

For example, the hydraulic machine described in each of the embodiments is a Francis turbine-type hydraulic machine; however, the micro-nano bubble generator 20 can be applied in hydraulic machines of other types such as a Kaplan turbine, a bulb turbine, and a Pelton turbine.

1. A hydraulic machine comprising:
an inlet section into which water flowing from an upper pond flows;
a runner configured to be rotated by water flowing out from the inlet section; and
an outlet section configured to flow out water flowing out from the runner to a lower stream,
the hydraulic machine further comprising a micro-nano bubble generator configured to generate water containing micro-nano bubbles, wherein
the micro-nano bubble generator supplies the water containing micro-nano bubbles to water flowing inside the hydraulic machine from a portion between the inlet section and the outlet section of the hydraulic machine.

2. The hydraulic machine according to claim 1, further comprising a draft tube configured to flow out water flowing out from the runner to the lower stream, wherein
the outlet section is provided at an end portion of the draft tube on a downstream side,
an injection port is formed on a wall surface of an upper draft of the draft tube, and
the micro-nano bubble generator supplies the water containing micro-nano bubbles to water flowing inside the hydraulic machine from the injection port.

3. The hydraulic machine according to claim 1, wherein
an injection port is formed at an end portion of the runner on a downstream side, and
the micro-nano bubble generator supplies the water containing micro-nano bubbles to water flowing inside the hydraulic machine from the injection port.

4. The hydraulic machine according to claim 1, further comprising a main shaft coupling the runner to an electric generator, wherein
an injection port is formed at an end portion of the main shaft on the side of the runner, and
the micro-nano bubble generator supplies the water containing micro-nano bubbles to water flowing inside the hydraulic machine from the injection port.

5. The hydraulic machine according to claim 1, further comprising a draft tube configured to flow out water flowing out from the runner to the lower stream, wherein
the outlet section is provided at an end portion of the draft tube on a downstream side,
a plurality of injection ports is formed on a wall surface of the draft tube, and
the micro-nano bubble generator supplies the water containing micro-nano bubbles to water flowing inside the hydraulic machine from the plurality of injection ports.

6. The hydraulic machine according to claim 1, further comprising:
a draft tube configured to flow out water flowing out from the runner to the lower stream; and
an air supply tube configured to supply air to the inside of the draft tube, wherein
the micro-nano bubble generator is connected to the air supply tube, and
the micro-nano bubble generator supplies the water containing micro-nano bubbles to water flowing inside the hydraulic machine through the air supply tube.

7. The hydraulic machine according to claim 1, further comprising a conduit tube configured to supply water flowing on an upstream side of the runner to the micro-nano bubble generator, wherein
the micro-nano bubble generator uses the water from the conduit tube to generate the water containing micro-nano bubbles and supplies the water containing micro-nano bubbles to a downstream side of the runner.

8. The hydraulic machine according to claim 1, further comprising:
a dissolved oxygen concentration measuring unit disposed on a downstream side of a supply position of the water containing micro-nano bubbles; and
a control unit configured to control a flow amount of the water containing micro-nano bubbles supplied by the micro-nano bubble generator and/or a mixed amount of the micro-nano bubbles mixed in the supplied water, wherein
the control unit controls, based on a measurement result of the dissolved oxygen concentration measuring unit, the flow amount of the water containing micro-nano bubbles supplied by the micro-nano bubble generator and/or the mixed amount of the micro-nano bubbles mixed in the supplied water.

9. A method for operating a hydraulic machine comprising an inlet section into which water flowing from an upper pond flows, a runner configured to be rotated by water flowing out from the inlet section, and an outlet section configured to flow out water flowing out from the runner to a lower stream, the method comprising the step of;
installing a micro-nano bubble generator configured to generate water containing micro-nano bubbles in the hydraulic machine; and
supplying the water containing micro-nano bubbles generated by the micro-nano bubble generator to water flowing inside the hydraulic machine from a portion between the inlet section and the outlet section of the hydraulic machine.
